(19) United States
(12) Patent Application Publication
(10) Pub. No.: US 2024/0253228 A1
(43) Pub. Date: Aug. 1, 2024

(54) METHOD OF GENERATING PROGRAM FOR ROBOTIC PROCESS

(71) Applicant: MakinaRocks Co., Ltd., Seoul (KR)

(72) Inventors: Jeyeol LEE, Seoul (KR); Goncalves Rocha YURI, Seoul (KR); Yu Jeong JEONG, Seoul (KR)

(73) Assignee: MakinaRocks Co., Ltd., Seoul (KR)

(21) Appl. No.: 18/424,408

(22) Filed: Jan. 26, 2024

(30) Foreign Application Priority Data
Jan. 30, 2023 (KR) 10-2023-0011505

(51) Int. Cl. B25J 9/16

(52) U.S. Cl. CPC B25J 9/1666; B25J 9/1602; B25J 9/163; B25J 9/1653; B25J 9/1676; B25J 9/1682

(57) ABSTRACT

Disclosed is a method of generating a program for a robotic process, the method being performed by a computing device, the method including: identifying valid working spots for a robot based on analyzing a pose of the robot; distributing one or more target working spots to the robot, based on estimating a distance between the valid working spots of the robot; and determining a work trajectory or work sequence of the robot in consideration of a possibility of collision of the robot.

### CROSS-REFERENCE TO RELATED APPLICATIONS

This application claims priority to and the benefit of Korean Patent Application No. 10-2023-0011505 filed in the Korean Intellectual Property Office on Jan. 30, 2023, the entire contents of which are incorporated herein by reference.

### TECHNICAL FIELD

The present disclosure relates to a method of generating a program for a robotic process, and more particularly, to a method of automating an Off-Line Programming (OLP) associated with a robotic process.

### BACKGROUND ART

Today, it is possible to increase productivity for each product by inserting multiple industrial robots in production. However, when a collision occurs between a robot and a product or a robot and a robot, the production process may be stopped and repair costs may be high.

For this reason, when a program for a robotic process is generated, an optimization process of designing the individual actions of the robots to complete the task in the least amount of time without colliding with each other is important.

On the other hand, an Off-Line Programming (OLP) method is being used as a way to generate programs for robotic processes. Herein, the OLP refers to designing a program for a robotic process in a simulation, testing the program, and then applying the generated program to a real robot. The offline programming has the advantage of being less time-consuming and avoiding costs incurred by actual collisions, compared to the online programming method where the robot is actually moved to generate the program for the robotic process. However, the offline programming generates the program in a non-automated (manual) manner that relies on the experience and judgment of the designer, which may result in important cases being missed in the optimization process, lots of wasted working time, and low efficiency.

Therefore, there is a demand for automation solutions that may solve the problems in the process of generating the robotic process program.

On the other hand, the present disclosure has been derived based on at least the technical background discussed above, but the technical problem or purpose of the present disclosure is not limited to solving the problems or disadvantages discussed above. That is, the present disclosure may cover various technical issues related to the content to be described below in addition to the technical issues discussed above.

### SUMMARY OF THE INVENTION

The present disclosure has been conceived to provide a solution to automate the process of generating a program for a robotic process by using an Off-Line Programming (OLP) method.

On the other hand, the technical problem to be achieved by the present disclosure is not limited to the technical problem mentioned above, and various technical problems may be included within the range obvious to those skilled in the art from the content to be described below.

An exemplary embodiment of the present disclosure provides a method of generating a program for a process using a robot, the method being performed by at least one computing device, the method including: identifying valid working spots for a robot based on analyzing a pose of the robot; distributing one or more target working spots to the robot, based on estimating a distance between the valid working spots of the robot; and determining a work trajectory of the robot in consideration of a possibility of collision of the robot.

In the exemplary embodiment, the robotic process may include a plurality of stations, each of the plurality of stations may include one or more robots, and the determining of the work trajectory or work sequence of the robot in consideration of the possibility of collision of the robot may include: planning, in the unit of station, the work trajectory of the robot in consideration of the possibility of collision of the robot; generating first feedback information in the unit of station about the plan; and redistributing one or more target working spots of the robots in the unit of station, based on the first feedback information.

In the exemplary embodiment, the determining of the work trajectory or work sequence of the robot in consideration of the possibility of collision of the robot may further include: generating second feedback information in the unit of entire process, based on an evaluation of the plan; redistributing target working spots of the robots in the unit of entire process based on the second feedback information; and re-planning the work trajectory or work sequence of the robot in the unit of station in consideration of the possibility of collision of the robot, after the redistribution in the unit of entire process.

In the exemplary embodiment, the identifying, based on analyzing the pose of the robot, the valid working spots for the robot may include: determining, when the robot is capable of taking at least one pose for working a specific working spot, the particular working spot as a valid working spot; and determining, for each valid working spot, a predetermined number or less of candidate work poses.

In the exemplary embodiment, the determining, when the robot is capable of taking at least one pose for working the specific working spot, the particular working spot as the valid working spot may include excluding the specific working spot from the valid working spots when the robot is capable of taking at least one pose for working the specific working spot, but the robot is predicted to be unable to enter the specific working spot.

In the exemplary embodiment, the robotic process may include a plurality of stations, each of the plurality of stations may include one or more robots, and the distributing of one or more target working spots to the robot may include distributing the one or more target working spots to the robot, in association with information about the station to which the robot belongs and information about the robot.

In the exemplary embodiment, the distributing of one or more target working spots to the robot may include distributing one or more target working spots to the robot based on distance information between the valid working spots of the robot predicted based on at least one operation of an operation of approximating a movement of the robot to a movement of a partial structure of the robot, an operation of predicting a linear movement between the valid working spots of the robot, and an operation of predicting a rotational movement between the valid working spots of the robot.

In the exemplary embodiment, the distributing of one or more target working spots may further include: calculating a cost value per robot based on distance information between the valid working spots of the robot; calculating a cost value per station based on the distance information between the valid working spots of the robot; and distributing one or more target working spots to the robot based on the cost value per robot and the cost value per station by utilizing a Genetic Algorithm (GA).

In the exemplary embodiment, the distributing of one or more target working spots to the robot may further include: calculating, based on work area information of the robot, a cost value associated with work area overlap; and distributing one or more target working spots to the robot based on the cost value per robot, the cost value per station, and the cost value associated with the work area overlap by utilizing the Genetic Algorithm (GA).

In the exemplary embodiment, the work area information of the robot may include volume information generated by filling the work trajectory of the robot with voxels.

In the exemplary embodiment, the determining of the work trajectory or work sequence of the robot in consideration of the possibility of collision of the robot may include: identifying overlap area information between work area information of the robot and work area information of another robot, and identifying an interfering adjustment signal generated in connection with the overlap area information; and determining the work trajectory or work sequence of the robot in consideration of the identified interfering adjustment signal.

In the exemplary embodiment, the determining of the work trajectory or work sequence of the robot in consideration of the identified interfering adjustment signal may include changing the work trajectory of the robot in a completely opposite direction.

In the exemplary embodiment, the determining of the work trajectory or work sequence of the robot in consideration of the possibility of collision of the robot may include: analyzing, when a collision of the robot is predicted, a possibility of resolving the predicted collision by utilizing a normal vector associated with a collision point; and determining the work trajectory of the robot based on a result of the analysis.

In the exemplary embodiment, the analyzing, when the collision of the robot is predicted, the possibility of resolving the predicted collision by utilizing a normal vector associated with a collision point includes at least one of calculating an average normal vector associated with the collision by utilizing a weight inversely proportional to a depth of penetration, and analyzing the possibility of resolving the predicted collision based on the calculated average normal vector; and analyzing the possibility of resolving the predicted collision by utilizing three different normal vectors.

In the exemplary embodiment, the program for the robotic process may include an Off-Line Programming (OLP) program, and the distributing of one or more target working spots to the robot may include distributing one or more target working spots to the robot by utilizing at least one of a Traveling Salesman Problem (TSP) solving algorithm and a Genetic Algorithm (GA), and the determining of the work trajectory of the robot may include determining the work trajectory for the robot by utilizing a trained neural network model or a path planning algorithm.

Another exemplary embodiment of the present disclosure provides a computer program stored in a computer-readable storage medium, wherein the program performs operations for generating a program for a robotic process by at least one processor, the operations including: identifying valid working spots for a robot based on analyzing a pose of the robot; distributing one or more target working spots to the robot, based on estimating a distance between the valid working spots of the robot; and determining a work trajectory or work sequence of the robot in consideration of a possibility of collision of the robot.

Another exemplary embodiment of the present disclosure provides a computing device including: at least one processor; and a memory, in which the processor identifies, based on analyzing a pose of a robot, valid working spots for the robot; distributes one or more target working spots to the robot, based on estimating a distance between the valid working spots of the robot; and determines a work trajectory of the robot in consideration of a possibility of collision of the robot.

The present disclosure may provide a solution to automate a process of generating a program for a robotic process by using an Off-Line Programming (OLP) method. Further, in connection with generating a program for a robotic process by using an OLP method, the present disclosure may provide solutions for reducing a search space utilized for distributing working spots, solutions for optimally distributing working spots to robots in a given search space, and solutions for preventing or avoiding collisions between robots.

On the other hand, the effect of the present disclosure is not limited to the above-mentioned effects, and various effects may be included within the range apparent to those skilled in the art from the content to be described below.

### BRIEF DESCRIPTION OF THE DRAWINGS

FIG. 1 is a block diagram of a computing device performing operations according to an exemplary embodiment of the present disclosure.

FIG. 2 is a schematic diagram illustrating a neural network according to the present disclosure.

FIG. 3 is a flowchart illustrating a schematic flow of a method of the present disclosure according to an exemplary embodiment of the present disclosure.

FIG. 4 is a schematic diagram related to distributing working spots to a robot.

FIG. 5 is a schematic diagram illustrating volume information representing a work trajectory of a robot according to the exemplary embodiment of the present disclosure.

FIG. 6 is a schematic diagram illustrating a partial structure of a robot that may be used according to the exemplary embodiment of the present disclosure.

FIG. 7 is a schematic diagram illustrating a matrix related to task distribution and sequence that may be generated based on a genetic algorithm according to the exemplary embodiment of the present disclosure.

FIG. 8 is a flowchart illustrating a schematic flow of a method of the present disclosure, including an entire process and station perspective according to an exemplary embodiment of the present disclosure.

FIG. 9 is a simple and general schematic diagram illustrating an example of a computing environment in which exemplary embodiments of the present disclosure are implementable.

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Further, a term “or” intends to mean comprehensive “or” not exclusive “or”. That is, unless otherwise specified or when it is unclear in context, “X uses A or B” intends to mean one of the natural comprehensive substitutions. That is, in the case where X uses A; X uses B; or, X uses both A and B, “X uses A or B” may apply to either of these cases. Further, a term “and/or” used in the present specification shall be understood to designate and include all of the possible combinations of one or more items among the listed relevant items.

Further, a term “include” and/or “including” shall be understood as meaning that a corresponding characteristic and/or a constituent element exists. Further, it shall be understood that a term “include” and/or “including” means that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Further, the term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

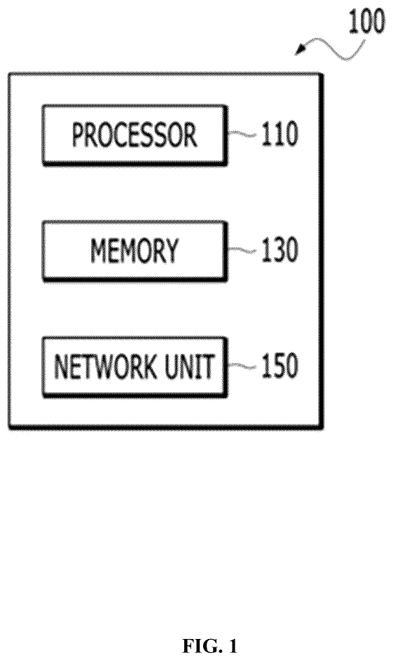

A configuration of the computing device 100 illustrated in FIG. 1 is only an example simplified and illustrated. In an exemplary embodiment of the present disclosure, the computing device 100 may include other components for performing a computing environment of the computing device 100, and only some of the disclosed components may constitute the computing device 100.

The computing device 100 may include a processor 110, a memory 130, and a network unit 150.

The processor 110 may be constituted by one or more cores, and include processors for data analysis and deep learning, such as a central processing unit (CPU), a general purpose graphics processing unit (GPGPU), a tensor processing unit (TPU), etc., of the computing device. The processor 110 may read a computer program stored in the memory 130 and process data for machine learning according to an exemplary embodiment of the present disclosure. According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, the GPGPU, and the TPU of the processor 110 may process learning of the network function. For example, the CPU and the GPGPU may process the learning of the network function and data classification using the network function jointly. In addition, in an exemplary embodiment of the present disclosure, the learning of the network function and the data classification using the network function may be processed by using processors of a plurality of computing devices together. In addition, the computer program performed by the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to several embodiments of the present disclosure may use various wired communication systems, such as a Public Switched Telephone Network (PSTN), an x Digital Subscriber Line (xDSL), a Rate Adaptive DSL (RADSL), a Multi Rate DSL (MDSL), a Very High Speed DSL (VDSL), a Universal Asymmetric DSL (UADSL), a High Bit Rate DSL (HDSL), and a local area network (LAN).

The network unit 150 presented in the present specification may use various wireless communication systems, such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

In the present disclosure, the network unit 110 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth. The techniques described herein may be used not only in the networks mentioned above, but also in other networks.

The reinforcement learning method of the present disclosure may use simulation models and reinforcement learning agents. Here, the simulation model is the entity that returns state information and rewards, and the reinforcement learning agent is the entity that determines behavior based on the state information and rewards. In the present disclosure, the contextual information may include contextual information at the current time and contextual information at the next time. Contextual information at the current time and contextual information at the next time may be categorized according to the time at which the contextual information was obtained. For example, based on the sequence in which the contextual information is generated, time points may be categorized as “t, t+1 t+2, t+3,” where “t, t+1 t+2, t+3” may be 1 second, 10 seconds, or 1 minute intervals. Specifically, a reinforcement learning agent according to the present disclosure may be trained based on at least one episode. In the present disclosure, the term “episode” may be used to mean a sequence of data having a sequence of order. An episode may be a dataset consisting of a plurality of E-tuple of data containing E elements (where E is a natural number equal to or greater than 1). The plurality of E-tuple of data included in the episode may have a sequence of orders. As an example of E-tuple of data, when E is ‘4’, each of 4-tuple data may include contextual information at the current time, a control action at the current time, a reward at the current time, and contextual information at the next time as elements. As another example of E-tuple of data, when E is ‘5’, each of 5-tuple data may include contextual information at the current time, a control action at the current time, a reward at the current time, contextual information at the next time, and a control action at the next time as elements.

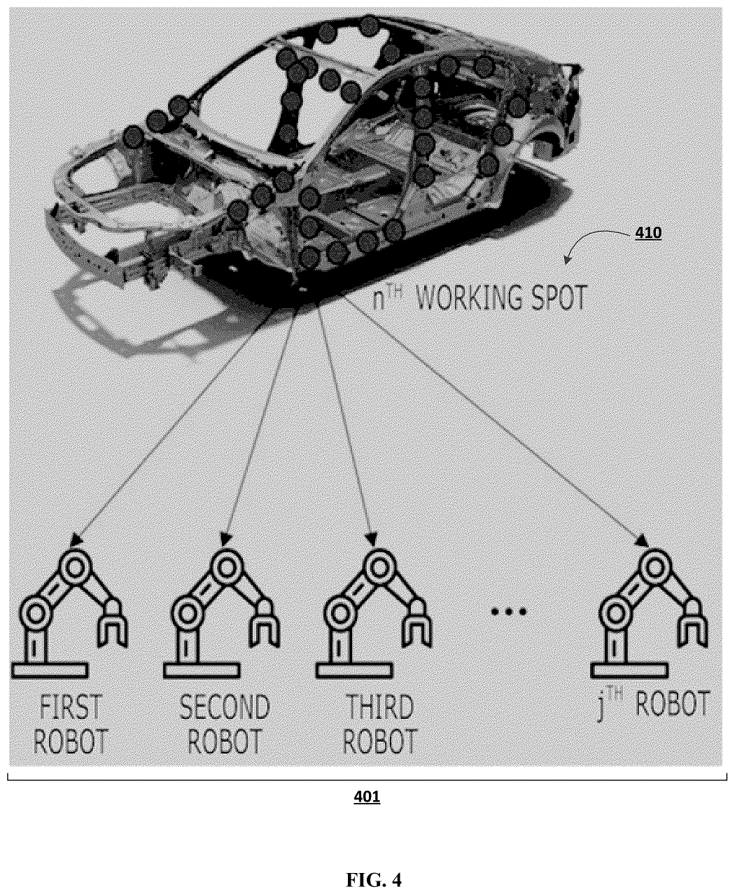

The process of the processor 110 performing reinforcement learning according to the present disclosure may include correcting a weight or a deviation value of each node of a neural network included in the reinforcement learning agent. The operation of correcting the weight or the deviation value of each node of a neural network included in the reinforcement learning agent may be performed by the processor 110 in the same or similar manner as the backpropagation technique for the neural network described with reference to FIG. 4. For example, when the reward (Rₜ) included in the training data at a predetermined time t is a positive number, the processor 110 may adjust the weight or a deviation value of one or more nodes included in the reinforcement learning agent such that the control behavior (Aₜ) at the predetermined time t included in the training data is reinforced. In this case, the one or more nodes included in the reinforcement learning control model may be nodes that were involved in determining the control action (Aₜ) after the reinforcement learning control model received the contextual information (Sₜ) included in the training data for the predetermined time t as input.

On the other hand, the reinforcement learning agent may determine a behavior on each state information in such a way that the cumulative value of the reward (that is, the return) is maximized. The method of determining the behavior by the reinforcement learning agent may be based on at least one of, for example, a value-based behavior determination method, a policy-based behavior determination method, or a behavior determination method based on both values and policies. The value-based behavior determination method is a method of determining behavior that gives the highest value in each state based on a value function. Examples of value-based behavioral decision method include Q-learning and Deep Q-Network (DQN). The policy-based behavior determination method is a method of determining behavior based on a final return and policy function without a value function. Examples of policy-based behavior determination method include the policy gradient technique. The behavior determination method based on both values and policies is a method of determining behavior of a reinforcement learning agent by learning in such a way that when the policy function determines the behavior, the value function evaluates the behavior. The behavior determination method based on both values and policies may include, for example, actor-critic algorithms, soft actor-critic algorithms, A2C algorithms, and A3C algorithms.

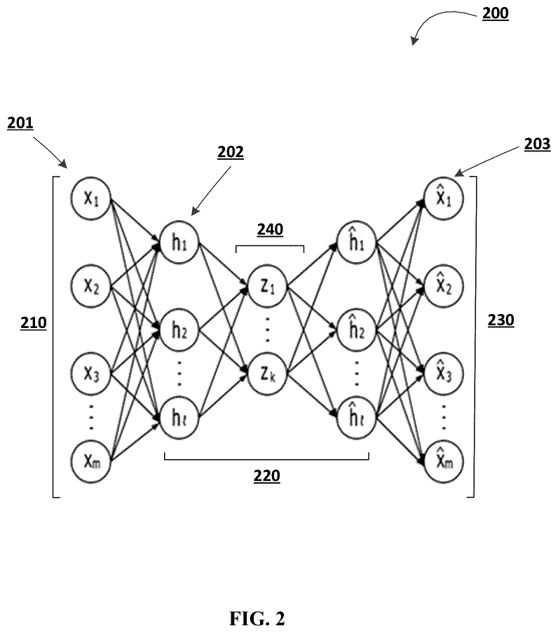

FIG. 2 is a schematic diagram illustrating a network function 200 according to the embodiment of the present disclosure.

Throughout the present specification, the meanings of a calculation model, a nerve network, the network function, and the neural network may be interchangeably used. The neural network may be formed of a set of interconnected calculation units which are generally referred to as “nodes”. The “nodes” may also be called “neurons”. The neural network consists of one or more nodes. The nodes (or neurons) configuring the neural network may be interconnected by one or more links.

In the neural network, one or more nodes connected through the links may relatively form a relationship of an input node 201 and an output node 203. The concept of the input node 201 is relative to the concept of the output node 203, and a predetermined node having an output node relationship with respect to one node may have an input node relationship in a relationship with another node, and a reverse relationship is also available. As described above, the relationship between the input node 201 and the output node 203 may be generated based on the link. One or more output nodes may be connected to one input node 201 through a link, and a reverse case may also be valid.

In the relationship between an input node 201 and an output node 203 connected through one link, a value of the output node data may be determined based on data input to the input node 201. Herein, a link connecting the input node 201 and the output node 203 may have a weight. The weight is variable, and in order for the neural network to perform a desired function, the weight may be varied by a user or an algorithm. For example, when one or more input nodes are connected to one output node by links, respectively, a value of the output node 203 may be determined based on values input to the input nodes connected to the output node 203 and weights set in the link corresponding to each of the input nodes.

As described above, in the neural network, one or more nodes are connected with each other through one or more links to form a relationship of an input node 201 and an output node 203 in the neural network. A characteristic of the neural network may be determined according to the number of nodes and links in the neural network, a correlation between the nodes and the links, and a value of the weight assigned to each of the links. For example, when there are two neural networks in which the numbers of nodes and links are the same and the weight values between the links are different, the two neural networks may be recognized to be different from each other.

The neural network may consist of a set of one or more nodes. A subset of the nodes configuring the neural network may form a layer. Some of the nodes configuring the neural network may form one layer on the basis of distances from an initial input node. For example, a set of nodes having a distance of n from an initial input node may form n layers. The distance from the initial input node may be defined by the minimum number of links, which need to be passed to reach a corresponding node from the initial input node. However, the definition of the layer is arbitrary for the description, and a degree of the layer in the neural network may be defined by a different method from the foregoing method. For example, the layers of the nodes may be defined by a distance from a final output node.

The initial input node may mean one or more nodes to which data is directly input without passing through a link in a relationship with other nodes among the nodes in the neural network. Otherwise, the initial input node may mean nodes which do not have other input nodes connected through the links in a relationship between the nodes based on the link in the neural network. Similarly, the final output node may mean one or more nodes that do not have an output node in a relationship with other nodes among the nodes in the neural network. Further, the hidden node 202 may mean nodes configuring the neural network, not the initial input node and the final output node.

In the neural network according to the embodiment of the present disclosure, the number of nodes of the input layer 210 may be the same as the number of nodes of the output layer 230, and the neural network may be in the form that the number of nodes decreases and then increases again from the input layer to the hidden layer 220. Further, in the neural network according to another embodiment of the present disclosure, the number of nodes of the input layer 210 may be smaller than the number of nodes of the output layer 230, and the neural network may be in the form that the number of nodes decreases from the input layer 210 to the hidden layer 220. Further, in the neural network according to another embodiment of the present disclosure, the number of nodes of the input layer 210 may be larger than the number of nodes of the output layer 230, and the neural network may be in the form that the number of nodes increases from the input layer 210 to the hidden layer 220. The neural network according to another embodiment of the present disclosure may be the neural network in the form in which the foregoing neural networks are combined.

A deep neural network (DNN) may mean the neural network including a plurality of hidden layers 220, in addition to an input layer 210 and an output layer 230. When the DNN is used, it is possible to recognize a latent structure of data. That is, it is possible to recognize latent structures of photos, texts, videos, voice, and music (for example, what objects are in the photos, what the content and emotions of the texts are, and what the content and emotions of the voice are). The DNN may include a convolutional neural network (CNN), a recurrent neural network (RNN), an auto encoder, Generative Adversarial Networks (GAN), a Long Short-Term Memory (LSTM), a transformer, a restricted Boltzmann machine (RBM), a deep belief network (DBN), a Q network, a U network, a Siamese network, a Generative Adversarial Network (GAN), and the like. The foregoing description of the deep neural network is merely illustrative, and the present disclosure is not limited thereto.

In the embodiment of the present disclosure, the network function may include an auto encoder. The auto encoder may be one type of artificial neural network for outputting output data similar to input data. The auto encoder may include at least one hidden layer 220, and the odd-numbered hidden layers may be disposed between the input/output layers. The number of nodes of each layer may decrease from the number of nodes of the input layer 210 to an intermediate layer called a bottleneck layer (encoding), and then be expanded symmetrically with the decrease from the bottleneck layer to the output layer 230 (symmetric with the input layer). The auto encoder may perform a nonlinear dimension reduction. The number of input layers and the number of output layers may correspond to the dimensions after preprocessing of the input data. In the auto encoder structure, the number of nodes of the hidden layer included in the encoder decreases as a distance from the input layer increases. When the number of nodes of the bottleneck layer 240 (the layer having the smallest number of nodes located between the encoder and the decoder) is too small, the sufficient amount of information may not be transmitted, so that the number of nodes of the bottleneck layer may be maintained in a specific number or more (for example, a half or more of the number of nodes of the input layer and the like).

The neural network may be trained by at least one scheme of supervised learning, unsupervised learning, semi-supervised learning, and reinforcement learning. The training of the neural network may be a process of applying knowledge for the neural network to perform a specific operation to the neural network.

The neural network may be trained in a direction of minimizing an error of an output. In the training of the neural network, training data is repeatedly input to the neural network and an error of an output of the neural network for the training data and a target is calculated, and the error of the neural network is back-propagated in a direction from an output layer 230 to an input layer 210 of the neural network in order to decrease the error, and a weight of each node of the neural network is updated. In the case of the supervised learning, training data labelled with a correct answer (that is, labelled training data) is used, in each training data, and in the case of the unsupervised learning, a correct answer may not be labelled to each training data. That is, for example, the training data in the supervised learning for data classification may be data, in which category is labelled to each of the training data. The labelled training data is input to the neural network and the output (category) of the neural network is compared with the label of the training data to calculate an error. For another example, in the case of the unsupervised learning related to the data classification, training data that is the input is compared with an output of the neural network, so that an error may be calculated. The calculated error is back-propagated in a reverse direction (that is, the direction from the output layer 230 to the input layer 210) in the neural network, and a connection weight of each of the nodes of the layers of the neural network may be updated according to the backpropagation. A change amount of the updated connection weight of each node may be determined according to a learning rate. The calculation of the neural network for the input data and the backpropagation of the error may configure a learning epoch. The learning rate is differently applicable according to the number of times of repetition of the learning epoch of the neural network. For example, at the initial stage of the learning of the neural network, a high learning rate is used to make the neural network rapidly secure performance of a predetermined level and improve efficiency, and at the latter stage of the learning, a low learning rate is used to improve accuracy.

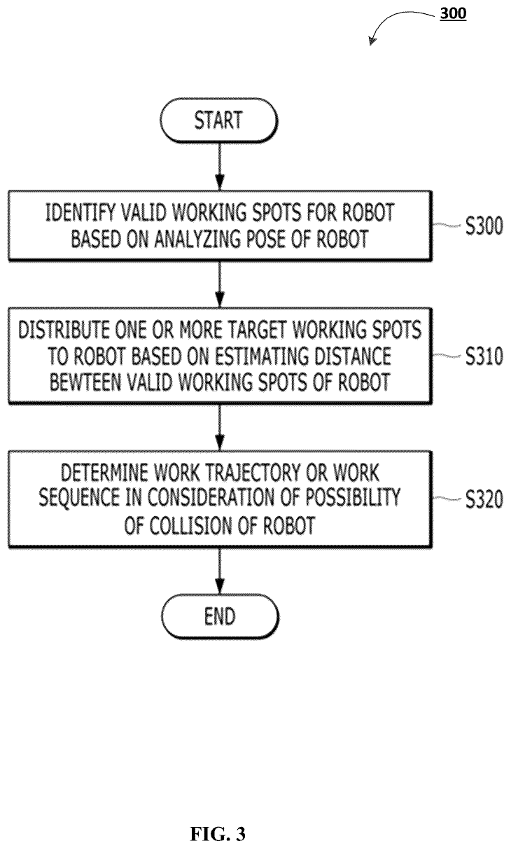

Hereinafter, an outlined process for a method of generating a program for a robotic process according to an exemplary embodiment of the present disclosure will be described with reference to operations S300 to S320 of FIG. 3.

First, a method 300 according to an exemplary embodiment of the present disclosure will be outlined with reference to FIG. 3. The method may include “identifying, by the processor 110, based on analyzing a pose of a robot, valid working spots for the robot” (operation S300), “distributing, by the processor 110, one or more target working spots to the robot, based on estimating a distance between the valid working spots of the robot” (operation S310), and “determining, by the processor 110, a work trajectory or work sequence of the robots in consideration of a possible collision of the robot” (operation S320).

Before describing each operation in detail, it should be noted that throughout the present disclosure, including operations S300 to S320, “robot” is often used in expressions that may be understood as singular for ease of presentation, but nevertheless, the robot may be understood as a concept encompassing a plurality of robots rather than a single entity, or a plurality of robots that include non-identical types of robots. For example, referring to operation S300, it is disclosed that the processor 110 identifies valid working spots for the robot based on analyzing the pose of the robot, but the robot is not limited to a single entity and may refer to each of a plurality of robots.

In the following, an exemplary embodiment of each of operations S300 to S320 will be disclosed. First, operation S300 includes identifying, based on analyzing a pose of the robot, valid working spots for the robot. The purpose of operation S300 is to generate valid working spots excluding working spots where working efficiency is very low or work is impossible when each robot works, before distributing the working spot to each robot. In the view of the effect, operation S300 may reduce the search space to be considered in subsequent operations, and may reduce the amount of computation required to generate a program.

In the exemplary embodiment related to operation S300, the processor 110 may perform “determining a specific working spots as a valid working spot when the robot takes at least one pose for working the particular working spot (S300-1)” and “determining, for each valid working spot, the predetermined number or less of candidate working poses (S300-2)” for identifying the valid working spot of the robot. For example, the processor 110 may determine whether each robot is capable of taking a pose to perform a task at a specific working spot by using an inverse kinematics solving algorithm for all working spots for each robot. As an illustrative example, referring to FIG. 4, the processor 110 may identify a valid working spot (e.g., the nth working spot 410) for each of the robots 401, based on whether the respective “robot r” is able to take a “pose p” to perform a task at a “specific working spot s”. Additionally, the processor 110 may generate [r, s, p] that is “robot identification information-valid working spot information-candidate pose information” in association with the valid working spot of each robot. In the exemplary embodiment, r may correspond to identification information of a specific robot (for example, the tenth robot), s may correspond to identification information of one valid working spot (for example, the 130^{th} working spot) among the valid working spots of the specific robot, and p may correspond to one or more candidate pose information associated with the one valid working spot (for example, information of an A pose, a B pose, and a C pose that the tenth robot may take in association with the 130^{th} working spot). In this case, the one or more candidate pose information may be limited to include only a predetermined number or fewer of the poses. For example, when a specific robot (for example, the 10^{th} robot) is capable of working in 10 candidate poses (for example, an A pose to a J pose) at one valid working spot (for example, the 130^{th} working spot) among the valid working spots of the specific robot, the 3 optimum candidate poses may be selected from among the 10 candidate poses so that only the 3 selected candidate poses are included in the search space. In an effect aspect, the above exemplary embodiment may have the effect that the number of candidate working poses may be adjusted in advance, thereby limiting the amount of computation that may occur when the processor 110 has a limited amount of computation available.

As a further exemplary embodiment, in relation to the aforementioned operation S300-1, “at least one pose for the robot to work the particular working spot” may be limited to “a pose that is valid by an inverse kinematics solution algorithm and at the same time does not have a risk of collision during the work process”. For example, the processor 110 may determine whether the robot is capable of taking “the pose that is valid by the inverse kinematics solution algorithm and at the same time does not have the risk of collision during the work process” by considering location information (for example, 3D Cartesian coordinates) and work direction information of the specific working spot, and only when the robot is capable of taking the pose, the processor 110 may determine the specific working spot to be a valid working spot. On the other hand, when the particular pose of the robot is valid by the inverse kinematics solution algorithm but is likely to cause a collision, the processor 110 may search additional poses by performing a change operation from the particular pose. For example, the processor 110 may perform a change operation to rotate the robot (or a partial structure of the robot) in the particular pose about a particular local axis (for example, the z-axis), and perform inverse kinematics operations to search additional poses. Further, the processor 110 may perform a change operation to translationally move the robot (or a partial structure of the robot) in the particular pose in the direction of the particular local axis (for example, z-axis), and perform inverse kinematics operations to search additional poses. In this case, the translational movement may be performed with an offset of 0.01 units from 0 to 0.01 m. Further, the processor 110 may perform a change operation to change the working direction of the robot (or a partial structure of the robot) in the particular pose, and perform inverse kinematics operations to search additional poses. On the other hand, in this case, the change of the work direction may be a change of flipping in the 180° opposite direction with respect to the particular local axis (for example, the z-axis).

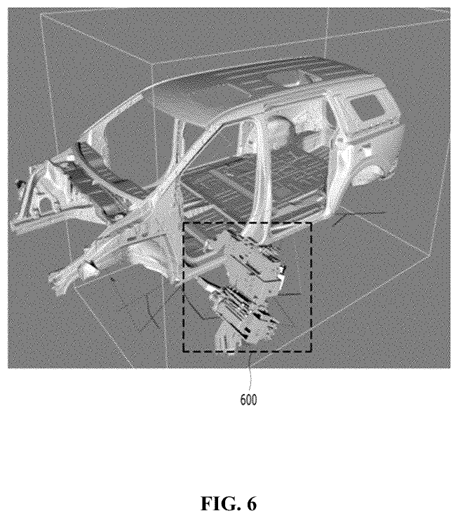

As a further exemplary embodiment, in relation to the aforementioned operation S300-1, the robot is capable of taking at least one pose for working the particular working spot, but when it is predicted that the robot is unable to enter the particular working spot, the processor 110 may exclude the particular working spot from the valid working spots. For example, when it is predicted that the robot is unable to enter the particular working spot due to a narrow passage available for entry or a collision upon entry, the particular working spot may be excluded from the group of valid working spots of the robot, even when it is simulated that the robot is able to take the pose to perform the particular task. Further, in the case where the angle at which the robot is capable of moving is limited in advance to prevent delay due to excessive movement, when the robot can take a pose to work on a particular working spot but cannot enter the specific working spot within the limited angle range, the particular working spot may also be excluded from the group of valid working spots of the robot. On the other hand, the operation “predicting whether the robot can enter the specific working spot” may be performed based on the operation “approximating the movement of the robot to the movement of a partial structure of the robot”. This method may be beneficial in terms of computational efficiency, as it requires much less computation amount, compared to the method using the structure of the entire robot. In one exemplary embodiment, the partial structure of the robot mayinclude a welder mounted on the robot, such as reference numeral 600 in FIG. 6, and may include other partial equipment or other parts of the robot in addition to the welder. In the aspect of the effect, when “using the entirety of the robot including the plurality of joints to predict whether the robot can enter” is compared with “performing the approximation based on the partial structure of the robot, such as a welder, to predict whether the robot can enter”, the amount of computation required in the latter case may be significantly reduced. Furthermore, since the case where “the approximated partial structure of the robot cannot enter” naturally corresponds to the case where “the (more complex) actual structure of the robot also cannot enter”, the case where “the robot cannot enter” can be accurately predicted even with such the approximation, and the reduction of the search space can be accurately performed based on this.

As a further exemplary embodiment, in relation to the aforementioned operation S300-2, the processor 110 may perform the operation of determining the predetermined number or less of candidate work poses by utilizing at least one information of “distance information to a center of mass of a work target,” “angle information between an axis of the work target and an axis of the robot,” or “distance information between a center of mass of the robot and a mesh vertex of the work target.” For example, in one exemplary embodiment using (1) the “distance information to the center of mass of the work target”, the processor 110 may give high priority to candidate work poses that can maximize the distance between the center of mass of the robot (or the center of mass of the work equipment of the robot) and the center of mass of the work target as much as possible. This is because, when the optimum candidate work poses are selected based on the criteria, the selected candidate work poses may be compatible with the valid working spots at similar locations, which may be helpful in the future when distributing target working spots to the robots or optimizing the paths of the robots. Next, in the exemplary embodiment using (2) “angle information between the axis of the work target and the axis of the robot,” the processor 110 may utilize “angle information between a global axis of the work target and a local axis of the robot.” Specifically, the processor 110 may select optimized candidate work poses based on angle information between “a global axis set from the inside to the outside of the work target” and “a specific local axis of the robot (for example, the x-axis of the robot or the y-axis of the robot).” This is because, when the optimum candidate work poses are selected based on the criteria, similar candidate work poses may be selected for valid working spots that exist on the same side of the work target, which may be helpful in the future when distributing target work points to robots or optimizing their paths. Next, in the exemplary embodiment using (3) “distance information between the center of mass of the robot and the mesh vertex of the work target”, the processor 110 may give high priority to candidate work poses that can maximize the distance between the “center of mass of the robot (or the center of mass of the work equipment of the robot)” and the “mesh vertex of the work target that is closest to the center of mass of the robot among the mesh vertices of the work target” as much as possible. This is because, when the optimum candidate work poses are selected based on the criteria, the candidate working poses with the secured stability may be selected and the risk of collisions may be reduced, which may help in the process of distributing target working spots to the robots or optimizing the paths of the robots in the future.

The operation S310, which may be performed following the operation S300, is an operation of distributing one or more target working spots to the robot, based on estimating a distance between the valid spots of the robot. Herein, the target working spot may refer to a working spot that is actually assigned to the robot. Thus, the operation S310 aims to distribute an optimum work spot such that when the robots simultaneously work on the working spots, no collisions occur and the work may be completed in the shortest time, based on the distance between the estimated valid working spots of the robots, prior to determining the work trajectory or work order of the robot.

On the other hand, the operation S310 may be performed at the unit of the entire process or at the unit of a station. For example, operation S310 may utilize (1) a method in which the working spots of the entire process are distributed directly among the individual robots, or (2) a method in which the working spots of the entire process are primarily distributed on at the unit of a station, and then the working spots distributed to each station are secondarily distributed among the robots within each station. (For reference, the station may also refer to a mid-level process unit that includes one or more robots, as described below. In other words, according to the exemplary embodiment of the present disclosure, the entire process may be divided into “individual robot unit→station unit including one or more robots→entire process unit including one or more stations”).

In the exemplary embodiment related to the method of “estimating a distance between the valid working spots of the robot (S310-1)” used for distributing the target working spots, the processor 110 may estimate a “distance between the valid working spots of the robot” based on at least one of (a) “an operation of approximating a movement of the robot as a movement of a partial structure of the robot (for example, a structure of a tool equipped in the robot)”, (b) “an operation of estimating a linear movement between the valid working spots of the robot”, and (c) “an operation of estimating a rotational movement between the valid working spots of the robot”. In this case, (a) “the operation of approximating a movement of the robot as a movement of a partial structure of the robot” may include an operation of approximating the movement of the robot to a movement of a partial structure of the robot, and then estimating a distance between two valid points based on the approximated movement. The approximating operation may reduce the amount of computation compared to the operation using the entire structure of the robot. In addition, when the partial structure corresponds to a work structure, the movement similar to the movement of the robot in the actual work process may be implemented, so the distance may be estimated with relatively high accuracy by the approximating operation. In the exemplary embodiment, the work structure of the robot may include the welder mounted on the robot, such as reference numeral 600 in FIG. 6, and the processor 110 may estimate the distance between the valid working spots of the robot by approximating the movement of the welder as a movement of the entire robot. Next, (b) “the operation of estimating a linear movement between the valid working spots of the robot” may include predicting whether it is possible to move between two valid working spots by, for example, a cartesian move or a linear move. In this case, when it is possible to move between the two valid working spots through a cartesian move, a linear move, or the like, the processor 110 may estimate that the distance between the two valid working spots is proportional to the Euclidean distance. Thus, through the operation, it is possible to perform the distance estimation operations while achieving relatively high computational efficiency. Next, (c) “the operation of estimating a rotational movement between the valid working spots of the robot” may include an operation of predicting a trajectory between two valid working spots of the robot where obstacle information is ignored, but predicting a distance between the two valid working spots in consideration of rotational motion and joint limits of the robot. This operation may take into account the rotational motion and rotational motion limitations of each robot, so that it is possible to estimate a distance with relatively high accuracy. On the other hand, the three operations reviewed above may also be utilized together, and the accuracy of distance estimation may be further improved by aggregating the distance information estimated by the three operations to estimate the final distance.

As a specific exemplary embodiment for distributing the target working spot to the robot after estimating the distance between the valid working spots of the robot (S310-1), the processor 110 may perform “calculating a cost value per robot based on the distance information between the valid working spots of the robot (S310-2),” “calculating a cost value per station based on the distance information between the valid working spots of the robot (S310-3)”, “calculating a cost value associated with a work area overlap based on work area information of the robot (S310-4)”, and “distributing one or more target working spots to the robot based on the cost value per robot, the cost value per station, and the cost value associated with the work area overlap by utilizing a genetic algorithm (S310-5)”.

The station is a mid-level process unit that includes one or more robots and may be generated by various criteria (location, work type, and the like). For example, robots clustered in a specific location in a factory may form one station, or robots performing the same type of work may form one station. In other words, the entire robotic process may be divided into a plurality of stations, and each of the plurality of stations may include one or more robots.

The cost value per robot and the cost value per station may be calculated, for example, by using a traveling salesman problem solving algorithm based on distance information that may be obtained in operation S310-1. For example, the cost value per robot may be calculated based on assuming a situation where target working spots are distributed to the robot, and calculating the minimum distance to visit all target working spots distributed by using a TSP-solving algorithm in the assumed distribution state. In the meantime, the TSP solving algorithm may include, for example, a meta-heuristic algorithm, such as a Guided Local Search (GLS) algorithm, and may include various other algorithms for solving TSPs in addition to these exemplary algorithms. Further, the cost value per station may be calculated by aggregating the cost values calculated in the above manner for the robots included in the station.

The cost value per robot may be utilized by the processor 110 after a weighting computation and a standard deviation operation. For example, the processor 110 may compute a standard deviation after weighting the cost values in the unit of robot, and utilize the computed standard deviation as the final cost in the unit of robot (for the currently assumed distribution situation). In this case, the weight may be calculated by considering the work time in the unit of robot.

The cost value per station may also be utilized by the processor 110 after the weighting computation and the averaging computation. For example, the processor 110 may weight the cost values in the unit of station and then compute an average, and utilize the computed average as the final cost in the unit of station (for the currently assumed distribution situation). In this case, the weight can be calculated by considering the work time in the unit of station.

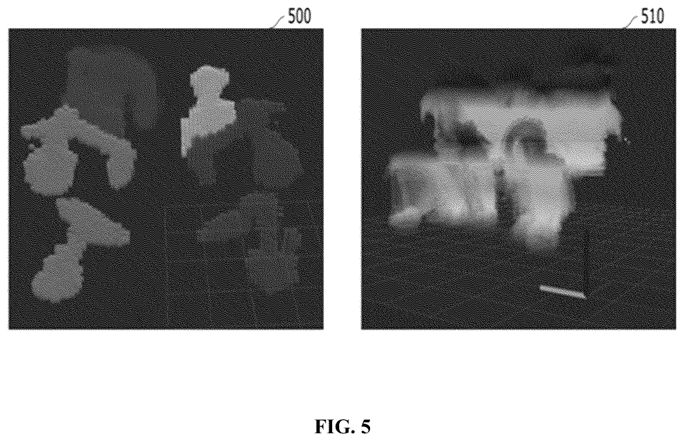

On the other hand, the aforementioned cost value per robot and cost value per station are related to how short time the distribution of target working spots can be processed when the target work spots are distributed. However, in the environment using the multiple robots, in addition to the time required, there may be issues with overlapping work areas between robots depending on how the target working spots are distributed. The overlap is a factor in increasing the possibility of collisions between robots, so the overlap may be included as an additional cost value. Therefore, the processor may further perform “calculating a cost value associated with the work area overlap based on the work area information of the robot (S310-4)”, and may further consider the cost value associated with the work area overlap in the process of distributing the target working spots. In this case, the “the work area information of the robot” may include swept volume information generated by a method of filling in voxels in the work trajectory of the robot. Furthermore, “the cost value associated with the work area overlap” may be calculated based on information about the overlap of the sweep volumes of the robots (for example, the number of overlapping voxels). As an illustrative example, referring to FIG. 5, reference numeral 500 may be understood to represent a situation where voxels are filled in the area of the robots in a default state (that is, in a waiting state before work), and reference numeral 510 may be understood to represent a situation where voxels are filled in the task trajectory in which the robots are moving. In cases such as reference numeral 510, overlap may exist between the voxels in the work trajectory.

Meanwhile, Genetic Algorithms (GAs) are a technology between computer science and biology, and are a method of solving problems by mimicking biological genetic material. Genetic algorithms may use a method of changing and optimizing combinations of genes to improve a program or find an unknown solution. The genetic algorithm of the present disclosure may be utilized to generate combinations of target working spots that are the valid working spots distributed to the robots, and may be utilized based on a random initialization method. However, this method may take a lot of time to search for the optimal value, and this time consumption is especially problematic when the task is highly iterative. On the other hand, the determination of the initial genes by using a non-random heuristic initialization method takes less time than the former, but may suffer from accuracy issues. Therefore, it is necessary to appropriately mix and use the random initialization method and the heuristic initialization method. Accordingly, in one exemplary embodiment, the processor 110 may utilize an initialization method that ensures that the number of target working spots distributed to each robot is as equal as possible. Further, in this case, the processor 110 may further define and utilize a “cost value associated with uniformity information of the number of target working spots distributed to each robot”.

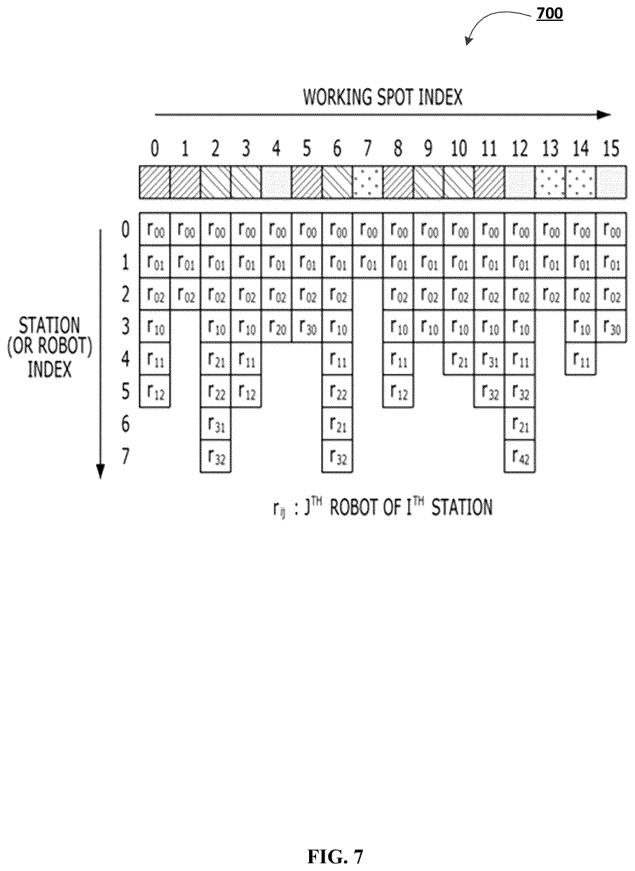

Referring now to FIG. 7, an example of a chromosome design 700 of a genetic algorithm according to the exemplary embodiment of the present disclosure is illustrated. Herein, rᵢⱼ denotes the j^{th} robot present at the i^{th} station. In addition, the horizontal index is an index for distinguishing between “work spots” and the vertical index is an index for distinguishing between “robots capable of performing work” that has a particular working spot as a valid working spot. In the exemplary embodiment, the chromosome may be generated based on selecting one of the robots capable of performing work listed in the vertical direction for each working spot, and in the example of FIG. 7, the body of the chromosome may be formed in the horizontal direction. For example, an exemplary chromosome may be organized as follows.
Example 1: (r₀₀, r₀₀, r₀₀, r₀₀, r₀₀, r₀₀, r₀₀, r₀₀, r₀₀, r₀₀, r₀₀, r₀₀, r₀₀, r₁₀, r₀₀, r₀₀)
Example 2: (r₀₁, r₀₂, r₃₂, r₁₀, r₂₀, r₀₂, r₀₂, r₀₁, r₀₁, r₀₁, r₀₁, r₀₁, r₀₁, r₁₀, r₀₀, r₀₀)

The operation S320 is an operation of determining a work trajectory or work sequence of the robot, in consideration of the possibility of collision of the robot, the purpose of operation S320 is to determine an optimized work trajectory or work sequence based on one or more target working spots that were distributed to the robot in the previous operation.

In connection with the operation 320, the processor 110 may determine a work trajectory or work sequence for the robot, in consideration of the possibility of collision of the robot. Here, considering the possibility of collision of the robot may include “considering whether a collision of the robot is expected” and “considering whether a collision of the robot can be avoided by a collision avoidance solution if expected”. For example, in connection with operation S320, if the processor 110 determines the work trajectory or work sequence of the robot based on reinforcement learning, the agent in reinforcement learning may perform the action by considering both “a reward that indicates whether a collision of the robot is expected” and “a reward that indicates whether a collision of the robot can be avoided by the collision avoidance solution if expected.

(Operation S320, Example-1) In one exemplary embodiment, the collision avoidance solution may include “a solution that utilizes an interfering adjustment signal (for example, an interlock signal) to pause some of the robots moving on a trajectory that is at risk of collision”. For example, operation S320 of determining the work trajectory or work sequence for the robot in consideration of the possibility of collision of the robot may include (1) “identifying, by the processor 110, overlap area information between work area information of the robot and work area information of another robot, and identifying an interfering adjustment signal (for example, an interlock signal) generated in association with the overlap area information” and (2) “determining a work trajectory or work sequence for the robot in consideration of the identified interfering adjustment signal”. (In this case, the overlap area may include the overlap of voxels in a virtual 3D environment where the work trajectory is filled with the voxels.)

(Operation S320, Example-2) As previously mentioned, the interfering adjustment signal (for example, an interlock signal) may pause some of the robots moving on a trajectory that is at risk of collision. However, even when there is an overlap area, when each robot in the corresponding area performs the work at a different point in time, there may be a situation where a pause is not required when the interfering adjustment signal (for example, an interlock signal) is generated. Therefore, there is a need for a way to prevent robots from concurrently performing work as much as possible in overlap areas that require the interfering coordination signals (for example, interlock signals). Accordingly, in the exemplary embodiment, the processor 110 may further perform “changing the work trajectory of the robot in a completely opposite direction” in relation to the “determining of the work trajectory or work sequence of the robot in consideration of the identified interfering adjustment signal”. For example, the processor 110 may determine a work trajectory or work sequence for the robot in a direction that minimizes concurrent work with another robot in the overlap region of the robot by attempting to change the work trajectory of the robot in a completely opposite direction and the like. For example, for the changing of the work trajectory of the robot to a completely opposite direction, when the existing work trajectory of the robot is to reach the target working spot in the order of A→B→C→D, the changing the work trajectory in the opposite direction may mean changing the existing work trajectory to reach the target working spot in the order of D→C→B→A. As a further example, when all three robots are working in the same direction at a station with three robots, the processor 110 may test by assuming that some of the three robots are working in the opposite direction and determine the work trajectory or work sequence with a combination having the least interfering adjustment signal (for example, interlock signal).

(Operation S320, Example-3) In determining the work trajectory or work sequence, when a sample-based planner, such as a Rapidly-exploring Random Tree (RRT) series, is used, there may occur a case where a sample is generated in the spot close to obstacles (for example, the structure of the work target). In this case, each sample exists in a position having no collision, but there is a possibility of collision on the movement path between the two samples. On the other hand, when Continuous Collision Detection (CCD) is used, a collision-free movement path may be generated, but there is the disadvantage of being slow to detect collisions, which increases the time required to determine the work trajectory or work sequence. In one exemplary embodiment related to the method for compromising the disadvantages, the collision avoidance solution may include “a solution for resolving the solution by utilizing a normal vector associated with the collision point”. For example, in connection with operation S320, the processor 110 may further perform “when a collision of the robot is predicted, analyzing the possibility of resolving the predicted collision by utilizing a normal vector associated with the collision point (for example, a normal vector to a plane or mesh including the collision point),” and determine a work trajectory or work sequence for the robot by utilizing the analyzed result. Furthermore, in connection with the additional operation, the processor 110 may perform an operation of, “where the collision of the robot is predicted, progressively moving an end effector of the robot (for example, a part corresponding to a hand if the robot mimics a human arm) associated with the collision in a normal direction associated with the collision point in the movement path of the robot until the collision does not occur” and analyze the possibility of resolving the collision based on this operation. In one exemplary embodiment, the processor 110 may perform “an operation of, when the collision of the robot is predicted, progressively moving an end effector of the robot associated with the collision in the normal direction until the robot reaches a predetermined maximum distance.” At this time, when the collision continues until the maximum distance is reached, the processor 110 may determine the work trajectory or work sequence of the robot to stop and work on another target working spot.

(Operation S320, Example-4) On the other hand, when a collision of the robot (for example, a collision of the robot with another robot or a collision of the robot with a work target) is detected by simulating a collision between a mesh and a mesh, the collision point and normal vector detected by the simulation may be obtained inaccurately. For example, if the triangles that make up the mesh representing the structure of the robot, other robots, or the work target have elongated shapes, the collision points and normal vectors may be calculated inaccurately. To solve these issues, the processor 110 may improve the normal vector used to resolve the collision by utilizing a weight inversely proportional to the depth of penetration (for example, the depth of the detected collision point based on the mesh structure). For example, with respect to the operation of “analyzing the possibility of resolving the predicted collision by utilizing the normal vector associated with the collision” discussed in the preceding exemplary embodiment, the processor 110 may further perform “computing a weighted average of the normal vectors of all collision points by utilizing a weight inversely proportional to the depth of penetration, to produce a (weighted) average normal vector, and analyzing the possibility of resolving the predicted collision based on the calculated (weighted) average normal vector.” On the other hand, the reason of utilization of the weight inversely proportional to the depth of penetration for each collision point is to reduce the impact of the depth of penetration, since the depth of penetration is larger, the size of the triangle in the mesh associated with corresponding collision is larger and there is a high possibility that the collision point is a false collision point or a false normal vector. Additionally, in connection with the operation of “analyzing the possibility of resolving the predicted collision by utilizing the normal vector associated with the collision” discussed in the preceding exemplary embodiment, the processor 110 may perform an operation of “analyzing the possibility of resolving the predicted collision by utilizing three different normal vectors”. The three different normal vectors may include: (a) a first normal vector (that is, the (weighted) average normal vector) calculated by computing a weighted average by using the weight inversely proportional to the depth of penetration, as discussed above, (b) a second normal vector calculated based on a plane containing the collision point and the center of mass of the mesh, and (c) a third normal vector calculated based on a plane including the first normal vector and the second normal vector. The processor 110 according to the exemplary embodiment of the present disclosure may explore various options for avoiding a collision at the collision point by utilizing these three normal vectors, thereby improving the possibility of collision avoidance. In particular, it is possible to improve the possibility of collision avoidance when collisions with different normal directions occur simultaneously at multiple points.

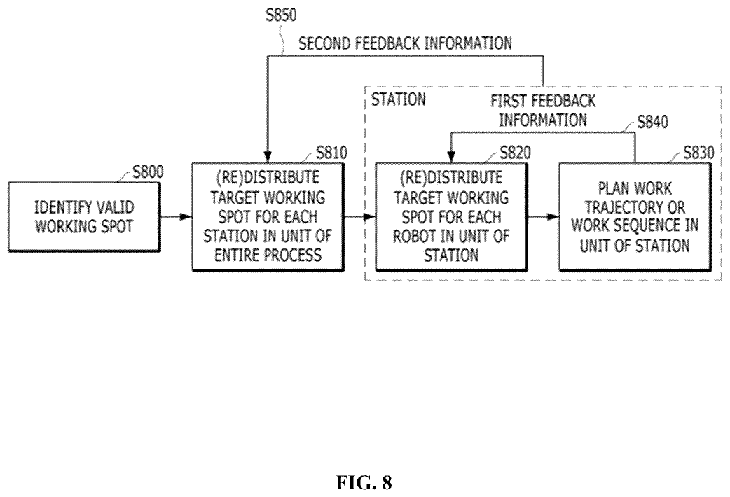

Based on operations S300 to S320, the outlined process of the present disclosure for the method of generating a program for a robotic process and the exemplary embodiments that may be used in each operation have been disclosed. Referring now to FIG. 8, one exemplary embodiment of the entire process and station perspective is disclosed.

First, the robotic process may include a plurality of stations, and each of the plurality of stations may include one or more robots.

Aforementioned operation S300 may correspond substantially to operation S800 of FIG. 8, and aforementioned operation S310 may correspond substantially to operations S810 and S820 of FIG. 8.

Next, the previously discussed operation S320 may be associated with S830, S840, S850, S820-RE (S820 from the redistribution perspective), S810-RE (S810 from the redistribution perspective), and the like of FIG. 8.

In the exemplary embodiment, referring to FIG. 8, operation S320 may include (1) operation S830 in which the processor 110, in the unit of station, plans a work trajectory for the robot in consideration of a possibility of collision of the robot, (2) operation S840 in which the processor 110 generates first feedback information in the unit of station about the plan, and (3) operation S820-RE in which the processor 110 redistributes one or more target working spots of the robots in the unit of station based on the first feedback information. In this case, the first feedback information may be generated based on information about a total work time expected by the planned work trajectory, whether a collision occurs by the planned work trajectory, whether there is a possibility to resolve the collision, a robot that has a collision, a time when the collision occurs, a location where the collision occurs, and a situation of a neighboring robot when the collision occurs. Further, the first feedback information may be associated with reward information for reinforcement learning, and planning the work trajectory of the robot or redistributing the target working spots may be associated with an action of the reinforcement learning. Further, the processor 110 may utilize the exemplary embodiments including Example-1 to Example-4 of operation S320 to redistribute the one or more target working spots of the robots in the unit of station based on the first feedback information.

S320 may include (4) operation S850 in which the processor 110 generates second feedback information of the unit of entire process based on an evaluation of the plan (for example, an evaluation of the plan in the unit of station), and (5) operation S810-RE in which the processor 110 redistributes the target working spots of the robots in the unit of entire process based on the second feedback information. For example, when the processor 110 evaluates the plan in the unit of station and concludes that it is difficult to obtain an optimum work trajectory by redistributing the target working spots in the unit of station alone, the processor 110 may generate the second feedback information in the unit of entire process, such that the target working spots are redistributed in the unit of entire process. In other words, through the second feedback information, the target working spots may be redistributed among the stations, beyond the unit of individual station. In one exemplary embodiment, the processor 110 may perform operation S810-RE of redistributing the target working spots of the robots in the unit of entire process based on the second feedback information by using algorithms, such as genetic algorithms, TSP solving algorithms, and random trees.

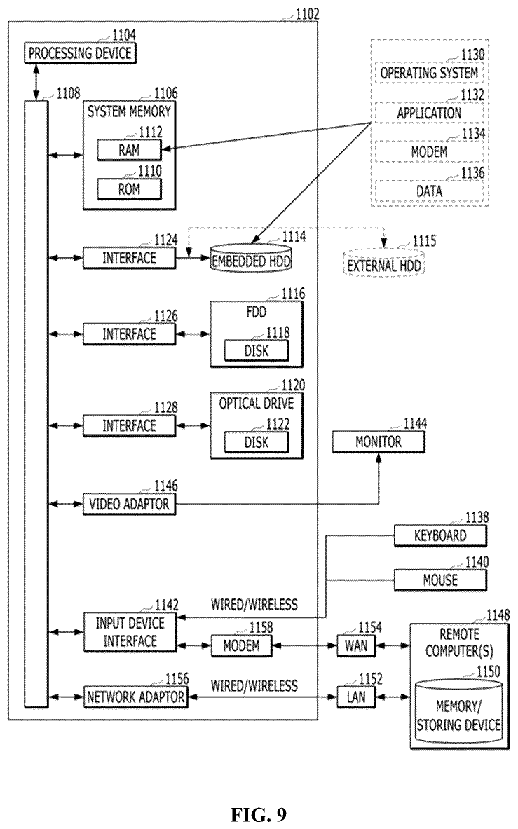

FIG. 9 is a simple and general schematic diagram illustrating an example of a computing environment in which the embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented embodiments is provided so as for those skilled in the art to use or carry out the present disclosure. Various modifications of the embodiments may be apparent to those skilled in the art, and general principles defined herein may be applied to other embodiments without departing from the scope of the present disclosure. Accordingly, the present disclosure is not limited to the embodiments suggested herein, and shall be interpreted within the broadest meaning range consistent to the principles and new characteristics presented herein.

What is claimed is:

1. A method of generating a program for a robotic process, the method being performed by a computing device, the method comprising:
identifying valid working spots for a robot based on analyzing a pose of the robot;
distributing one or more target working spots to the robot, based on estimating a distance between the valid working spots of the robot; and
determining a work trajectory or work sequence of the robot in consideration of a possibility of collision of the robot,
wherein the distributing of the one or more target working spots to the robot, based on estimating the distance between the valid working spots of the robot comprises:
calculating a cost value per robot based on distance information between the valid working spots of the robot;
calculating a cost value per station based on the distance information between the valid working spots of the robot; and
distributing the one or more target working spots to the robot based on the cost value per robot and the cost value per station by utilizing a Genetic Algorithm (GA).

2. The method of claim 1, wherein the robotic process comprises a plurality of stations,
wherein each of the plurality of stations comprises one or more robots, and
wherein the determining of the work trajectory or work sequence of the robot in consideration of the possibility of collision of the robot comprises:
planning, in a unit of station, the work trajectory of the robot in consideration of the possibility of collision of the robot;
generating first feedback information in the unit of station about the plan; and
redistributing the one or more target working spots of the robots in the unit of station, based on the first feedback information.

3. The method of claim 2, wherein the determining of the work trajectory or work sequence of the robot in consideration of the possibility of collision of the robot further comprises:
generating second feedback information in a unit of entire process, based on an evaluation of the plan;
redistributing target working spots of the robots in the unit of entire process based on the second feedback information; and
re-planning the work trajectory or work sequence of the robot in the unit of station in consideration of the possibility of collision of the robot, after the redistribution in the unit of entire process.

4. The method of claim 1, wherein the identifying, based on analyzing the pose of the robot, the valid working spots for the robot comprises:
determining, when the robot is capable of taking at least one pose for working a specific working spot, the specific working spot as a valid working spot; and
determining, for each valid working spot, a predetermined number or less of candidate work poses.

5. The method of claim 4, wherein the determining, when the robot is capable of taking at least one pose for working the specific working spot, the specific working spot as the valid working spot comprises:
excluding the specific working spot from the valid working spots when the robot is capable of taking at least one pose for working the specific working spot, but the robot is predicted to be unable to enter the specific working spot.

6. The method of claim 4, wherein the determining, for each valid working spot, the predetermined number or less of candidate work poses comprises determining, the predetermined number or less of candidate work poses by using at least one of:
distance information to a center of mass of a work target;
angle information between an axis of the work target and an axis of the robot; or
distance information between a center of mass of the robot and a mesh vertex of the work target.

7. The method of claim 1, wherein the robotic process comprises a plurality of stations,
wherein each of the plurality of stations comprises one or more robots, and
wherein the distributing of the one or more target working spots to the robot comprises:
distributing the one or more target working spots to the robot, in association with information about the station to which the robot belongs and information about the robot.

8. The method of claim 1, wherein the distributing of the one or more target working spots to the robot comprises distributing the one or more target working spots to the robot based on distance information between the valid working spots of the robot predicted based on at least one operation of:
an operation of approximating a movement of the robot to a movement of a partial structure of the robot;
an operation of predicting a linear movement between the valid working spots of the robot; or
an operation of predicting a rotational movement between the valid working spots of the robot.

9. The method of claim 1, wherein the distributing of the one or more target working spots to the robot further comprises:
calculating, based on work area information of the robot, a cost value associated with work area overlap; and
distributing the one or more target working spots to the robot based on the cost value per robot, the cost value per station, and the cost value associated with the work area overlap by utilizing the Genetic Algorithm (GA).

10. The method of claim 9, wherein the work area information of the robot comprises volume information generated by filling the work trajectory of the robot with voxels.

11. The method of claim 1, wherein the determining of the work trajectory or work sequence of the robot in consideration of the possibility of collision of the robot comprises:
identifying overlap area information between work area information of the robot and work area information of another robot, and identifying an interfering adjustment signal generated in connection with the overlap area information; and
determining the work trajectory or work sequence of the robot in consideration of the identified interfering adjustment signal.

12. The method of claim 11, wherein the determining of the work trajectory or work sequence of the robot in consideration of the identified interfering adjustment signal comprises:
changing the work trajectory of the robot in a completely opposite direction.

13. The method of claim 1, wherein the determining of the work trajectory or work sequence of the robot in consideration of the possibility of collision of the robot comprises:
analyzing, when a collision of the robot is predicted, a possibility of resolving a predicted collision by utilizing a normal vector associated with a collision point; and
determining the work trajectory of the robot based on a result of the analyzing, when the collision of the robot is predicted, the possibility of resolving the predicted collision.

14. The method of claim 13, wherein the analyzing, when the collision of the robot is predicted, the possibility of resolving the predicted collision by utilizing the normal vector associated with the collision point comprises at least one of:
calculating an average normal vector associated with the collision by utilizing a weight inversely proportional to a depth of penetration, and analyzing the possibility of resolving the predicted collision based on the calculated average normal vector; or
analyzing the possibility of resolving the predicted collision by utilizing three different normal vectors.

15. The method of claim 1, wherein the program for the robotic process comprises an Off-Line Programming (OLP) program, and
wherein the distributing of the one or more target working spots to the robot comprises:
distributing the one or more target working spots to the robot by utilizing at least one of a Traveling Salesman Problem (TSP) solving algorithm and the Genetic Algorithm (GA), and
wherein the determining of the work trajectory of the robot comprises:
determining the work trajectory for the robot by utilizing a trained neural network model or a path planning algorithm.

16. A computer program stored in a non-transitory computer-readable storage medium, the program causing at least one processor to perform operations for generating a program for a robotic process, the operations comprising:
identifying valid working spots for a robot based on analyzing a pose of the robot;
distributing one or more target working spots to the robot, based on estimating a distance between the valid working spots of the robot; and
determining a work trajectory or work sequence of the robot in consideration of a possibility of collision of the robot,
wherein the distributing of one or more target working spots to the robot, based on estimating the distance between the valid working spots of the robot comprises:
calculating a cost value per robot based on distance information between the valid working spots of the robot;
calculating a cost value per station based on the distance information between the valid working spots of the robot; and
distributing one or more target working spots to the robot based on the cost value per robot and the cost value per station by utilizing a Genetic Algorithm (GA).

17. A computing device, comprising:
at least one processor; and
a memory,
wherein the at least one processor is configured to:
identify, based on analyzing a pose of a robot, valid working spots for the robot;
distribute one or more target working spots to the robot, based on estimating a distance between the valid working spots of the robot; and
determine a work trajectory or work sequence of the robot in consideration of a possibility of collision of the robot, and
wherein the distributing of one or more target working spots to the robot, based on estimating the distance between the valid working spots of the robot comprises:
calculating a cost value per robot based on distance information between the valid working spots of the robot;
calculating a cost value per station based on the distance information between the valid working spots of the robot; and
distributing one or more target working spots to the robot based on the cost value per robot and the cost value per station by utilizing a Genetic Algorithm (GA).
